(19) United States
(12) Patent Application Publication
(10) Pub. No.: US 2016/0138955 A1
(43) Pub. Date: May 19, 2016

(54) FLUID LOSS SENSOR AND METHOD

(71) Applicant: SHELL OIL COMPANY, Houston, TX (US)

(72) Inventors: Fedderik VAN DER BOS, Rijswijk (NL); Jesper Wilhelmus WENTINK, Rijswijk (NL)

(21) Appl. No.: 14/904,928

(22) PCT Filed: Jul. 14, 2014
(86) PCT No.: PCT/EP2014/065009

§ 371 Date: Jan. 13, 2016

(30) Foreign Application Priority Data
Jul. 16, 2013 (EP) 13176616.4

(51) Int. Cl. G01F 15/12; E21B 21/01; E21B 7/00

(52) U.S. Cl. CPC G01F 15/12; E21B 7/00; E21B 21/01

(57) ABSTRACT

The invention discloses a sensor and method for measuring fluid loss. The fluid loss sensor comprises: a first fluid container, comprising a permeable section, a fluid inlet and a first fluid outlet; a second fluid container enclosing an outer surface of the permeable section and having a second fluid outlet; and a fluid flow sensor for measuring fluid flow in the fluid outlet. The sensor comprises automated cleaning means, enabling automated cleaning for an automated drilling operation.

The present invention relates to a sensor and method for monitoring fluid loss. The method and system of the invention can be used to measure loss of drilling fluid during drilling operations, including but not limited to the drilling of a borehole for or related to the production of hydrocarbons.

Boreholes are typically drilled using drilling systems comprising a drill string provided with a drill bit at the downhole end thereof. The drilling system may include a rotary drive system at surface to rotate the drill string including the drill bit. Alternatively or in addition, a downhole motor may be included in the drill string near the drill bit for rotating the drill bit. The borehole may include vertical sections and sections deviating from vertical, e.g. horizontal sections.

The drill string typically includes drill pipe sections which are mutually connected by threaded couplings. The drive system may provide torque to the drill string to rotate the drill string. The drive system may include, for example, a top drive or a rotary table. The drill string transmits the rotational motion to the drill bit. Generally the drill string also transmits drilling fluid to the drill bit.

The drilling fluid may relate to any of a number of liquid or gaseous fluids and mixtures of fluids and solids used in operations to drill boreholes into the earth. The solids may be mixed in the fluid as solid suspensions, mixtures and emulsions of liquids, gases and solids. The term “mud” may also be used, and is synonymous with “drilling fluid” in general usage. The term “drilling fluid” however may also include more sophisticated and well-defined “muds”. Drilling fluids may be classified by singling out a component that defines the function and performance of the fluid. Thus, the drilling fluid may be classified as: (1) water-based; (2) oil or non-water-based; and (3) gaseous (pneumatic). Each category has a variety of subcategories that overlap each other considerably. Each composition provides different solutions in the well. If rock formation is composed of salt or clay, proper action must be taken for the drilling fluids to be effective. In fact, a drilling fluid engineer oversees the drilling, adding drilling fluid additives throughout the process to achieve more buoyancy or minimize friction, whatever the need may be.

In addition to considering the chemical composition and properties of the well, a drilling fluid engineer must also take environmental impact into account when prescribing the type of drilling fluid necessary in a well. Oil-based drilling fluids may work better with a saltier rock. Water-based drilling fluids are generally considered to affect the environment less during offshore drilling.

During drilling, drilling fluid may be lost to the formation due to the overbalance (i.e. higher pressure) of the fluid inside the borehole compared to the pressure of fluids in the formation. In order to mitigate the amount of drilling fluid that is lost to the formation, additives are added to the fluid for forming a filter cake, thereby effectively plastering the wall of the borehole. The additives plug off pores in the borehole wall to prevent the fluid from leaking into the formation. However, as the filter cake is typically not entirely impermeable, drilling fluid may still be lost to the formation.

While drilling the borehole, it is often important to quantify the loss of drilling fluid to the formation. Excessive fluid loss may lead to one or more of the following disadvantages: Increased costs due to loss of (potentially expensive) drilling fluid; damage of hydrocarbon bearing formations, which may reduce oil and gas recovery; the creation of borehole instability problems due to equalization of pore pressures in the borehole wall; etc.

Traditionally, the ability of the drilling fluid to seal the pores of the formation is measured with an API fluid loss cell. The cell measures the amount of fluid that is lost during a certain time period. Such fluid loss cell is a fluid container which is sealed by a removable screen and filter paper. Rubber gaskets are provided to seal parts with respect to each other. The container is then pressurized up to a predetermined pressure and the fluid leaking through the assembly of screen and filter paper is collected and measured. After a predetermined test time period, typically 10 to 30 minutes, the pressure is released and the residue on the filter paper is visually inspected. A fluid loss cell is for instance available at Fann Instrument Company, Houston, USA.

Using the API fluid loss cell is a labour intensive and time consuming procedure. By definition, a single test procedure will take at least the test time period, which is typically 30 minutes. In addition, the visual inspection of the filter paper at the end of the test is subjective, i.e. the results of the test may vary per person and depending on circumstances, and the accuracy of the test is therefore limited. Furthermore, the test may easily fail when any of the rubber gaskets of the fluid loss cell is inserted in the wrong way.

As described above, the fluid loss cell currently works in a batch mode. Each time, a fluid sample needs to be placed in the cell. Due to the labour intensive nature of the test, it is only performed a few times a day. By contrast, drilling fluid properties, and more specifically the ability of the drilling fluid to seal the formation and form a good quality filter cake, can change drastically in only a few minutes time due to, for instance, contamination of the mud with fine particles, exposure to extreme pH, salt, cement, gypsum, etc.

For static fluid loss cells samples have to be taken that need to be placed inside the fluid loss cell and only then the measurement can start, which takes around 20 to 30 minutes. In order to automate this process, most likely a robot will be required which has a lot of moving parts and therefore increases the chance of breakdown, whereas each test will still take approximately 20 to 30 minutes. For automation of drilling fluid control this is too slow.

WO-2008/144164-A1 discloses a re-usable filter for testing drilling fluids. This is a batch type system, having associated disadvantages as described above.

WO-2011/095600-A2 discloses an automated fluid loss system (AFLS). A more detailed description of the AFLS seems to be provided in conference-paper SPE-112687-MS, which discloses a drilling system, including a “pressurized fluid loss sensor G”. This is a cell-type measurement device, which allows for continuous measurement. The cell includes a metallic mesh filter which can be removed and cleaned for re-use. One outlet of the cell is covered with the filter, upon which a filter cake builds. Another outlet allows continuous mud flow.

US-2009/217776 provides a mud property sensor system. A sample volume of mud is introduced in a chamber, which is subsequently pressurized, so that the mud is forced through a membrane.

U.S. Pat. No. 4,790,933 discloses a dynamic filtration unit, comprising concentric cylinders. An inner cylinder includes a permeable section and an enclosing cylinder provides an outlet for removing test fluid. The filter unit measures total fluid loss over time. Suitable filters include any conventional filters known in the art and include both natural and artificial filters. The system of U.S. Pat. No. 4,790,933 assumes that the quantity of filtrate is a direct measure of fluid leaking into the formation while drilling.

U.S. Pat. No. 5,361,631 discloses an apparatus and methods for determining the shear stress required for removing drilling fluid deposits. The apparatus includes a container comprising a permeable medium for simulating a permeable subterranean formation. A fine mesh screen simulating the permeable formation is disposed between two cavities, one thereof simulating a well bore. A pressure differential is applied to simulate a permeable wellbore section. An output of the apparatus may be processed to obtain information on fluid loss behavior.

The apparatus of U.S. Pat. No. 5,361,631 however is unsuitable for continuous use, as it must be taken apart periodically for cleaning. As the device is unsuitable for multiple repeated measurements, one might just as well use the existing API fluid loss cell. The apparatus is not an automated sensor but rather provides a series of respective measurements, each requiring human intervention at the end.

The present invention aims to improve the monitoring of drilling fluid properties.

The present invention provides a fluid loss sensor comprising:

a first fluid container, comprising a permeable section, a fluid inlet and a first fluid outlet;

a second fluid container enclosing an outer surface of the permeable section and having a second fluid outlet; and

a fluid flow sensor for measuring fluid flow in the fluid outlet.

The fluid loss sensor of the invention can operate with minimal human intervention. The sensor therefore circumvents many of the above mentioned issues. The sensor can operate continuously. The sensor can therefore present the driller with information regarding the sealing properties of the fluid substantially continuously. In any case, the sensor provides fluid loss information much more frequently than would be possible using the industry standard batch process mentioned above. The sensor of the invention is suitable for automated drilling, which requires sensors that continuously measure fluid properties, including fluid loss.

In an embodiment, the first fluid container is a first pipe, and the second fluid container is a second pipe enclosing the first pipe.

The sensor may comprise an inflow control valve to control inflow of fluid into the fluid inlet.

In addition, the sensor may comprise a cleaning assembly. In this embodiment, the sensor can automatically clean itself once the permeable medium has been covered with a filter cake and when measured fluid loss has dropped below a predetermined threshold.

In an embodiment, the cleaning assembly comprises:

a cleaning fluid reservoir comprising cleaning fluid;

a cleaning fluid conduit connecting the cleaning fluid reservoir to the fluid outlet of the second fluid container; and

a pump for pumping said cleaning fluid into the fluid outlet.

The cleaning assembly of the above embodiment enables automatic removal of the filter cake by reverse circulation of cleaning fluid. Automatic removal herein allows the device of the invention to function autonomous, without human intervention, for a prolonged period of time. The autonomous operation of the sensor is ideal for an automated drilling operation. Until automated drilling has been realized, the sensor of the invention may save time and associated costs when incorporated in conventional drilling operations.

Optionally, the cleaning assembly further comprises:

a cleaning fluid discharge tank.

In another embodiment, the cleaning assembly further comprises:

a valve for opening and closing the cleaning fluid conduit;

a valve for opening and closing fluid passage to the flow rate sensor;

a valve for opening and closing fluid passage to the cleaning fluid discharge tank.

In a preferred embodiment, a permeability of the permeable section is substantially equal to a formation permeability. In this embodiment, the fluid loss measured by the sensor will accurately indicate the fluid loss in the formation. Additives in the drilling fluid will build up a filter cake on the permeable section of the sensor, similar to the filter cake on the wall of the borehole.

According to another aspect, the invention provides a drilling system for drilling a borehole, comprising the sensor as described above.

According to yet another aspect, the invention provides a method for monitoring fluid loss, comprising the steps of:

guiding at least part of a fluid stream to a fluid inlet of a first fluid container, the first container comprising a permeable section and a first fluid outlet;

providing a second fluid container enclosing an outer surface of the permeable section and having a second fluid outlet; and

measuring fluid flow in the second fluid outlet using a fluid flow sensor.

The invention will be described in more detail and by way of example herein below with reference to the accompanying drawings, in which:

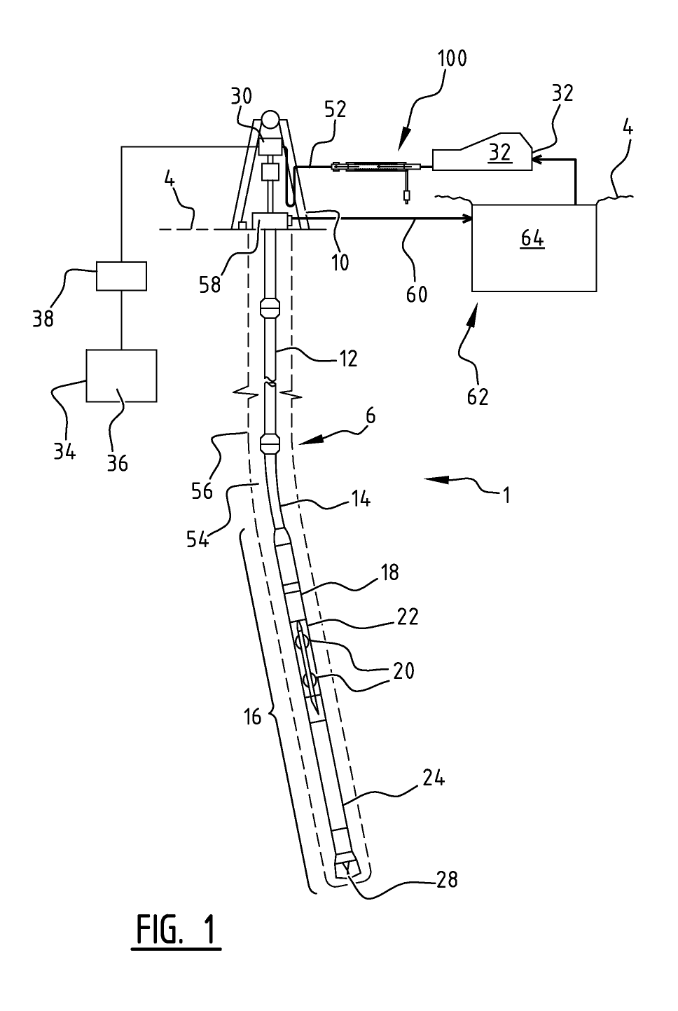

FIG. 1 shows a cross section of an embodiment of a drilling system including a fluid loss sensor of the invention;

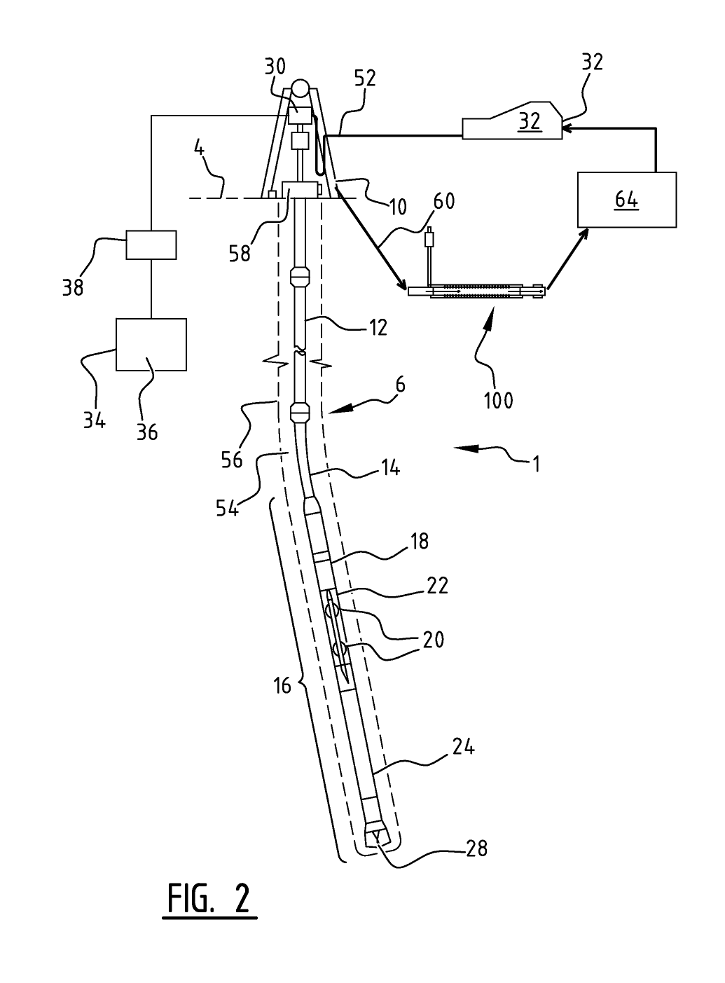

FIG. 2 shows a cross section of another embodiment of a drilling system including the fluid loss sensor of the invention;

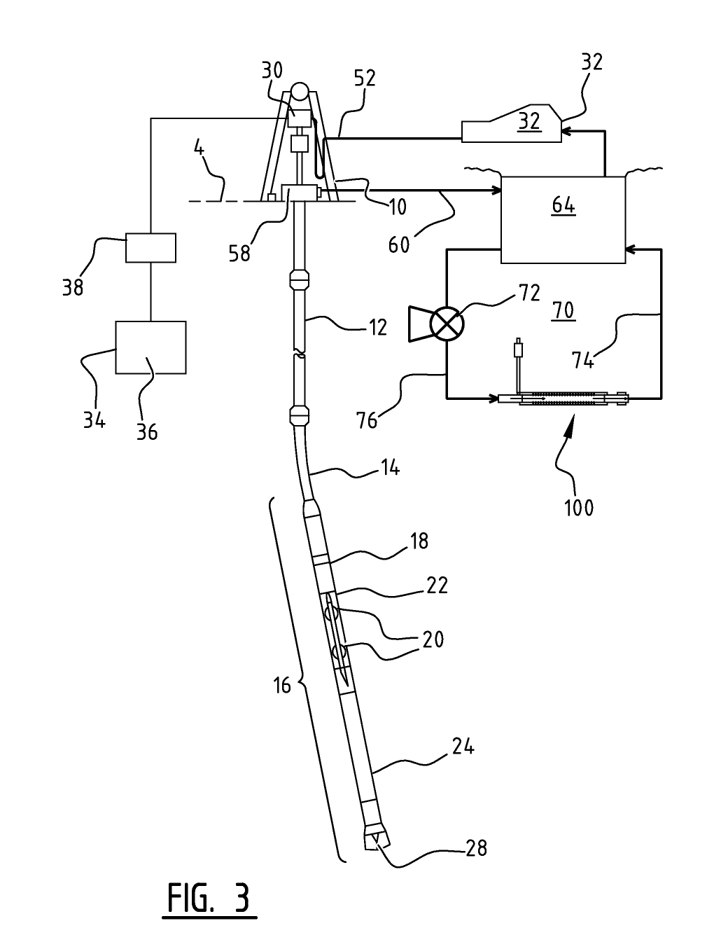

FIG. 3 shows a cross section of yet another embodiment of a drilling system including the fluid loss sensor of the invention;

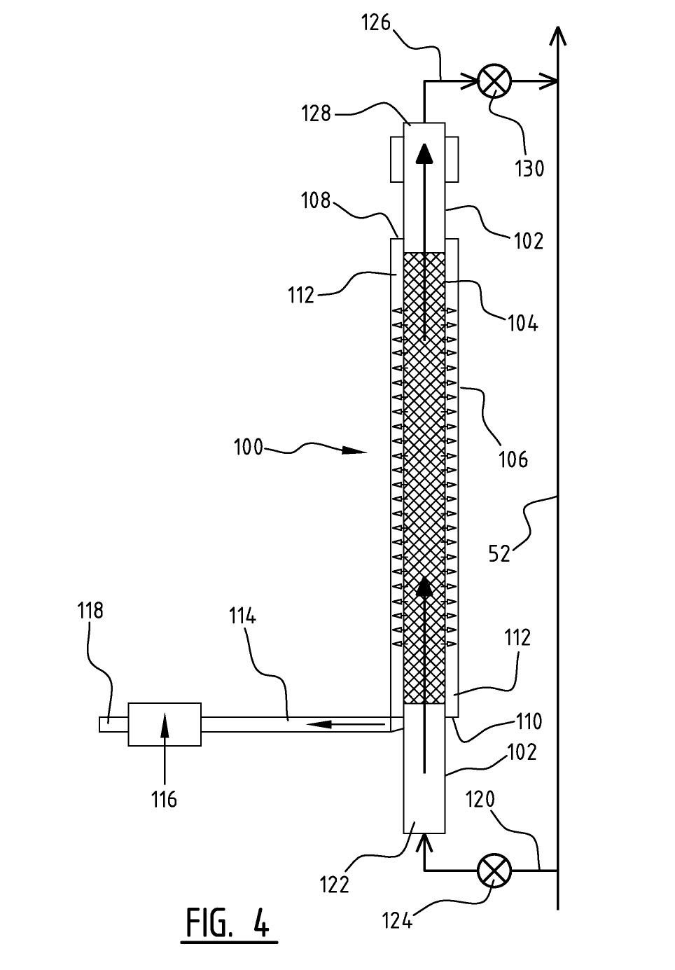

FIG. 4 shows a cross section of an embodiment of the fluid loss sensor according to the invention;

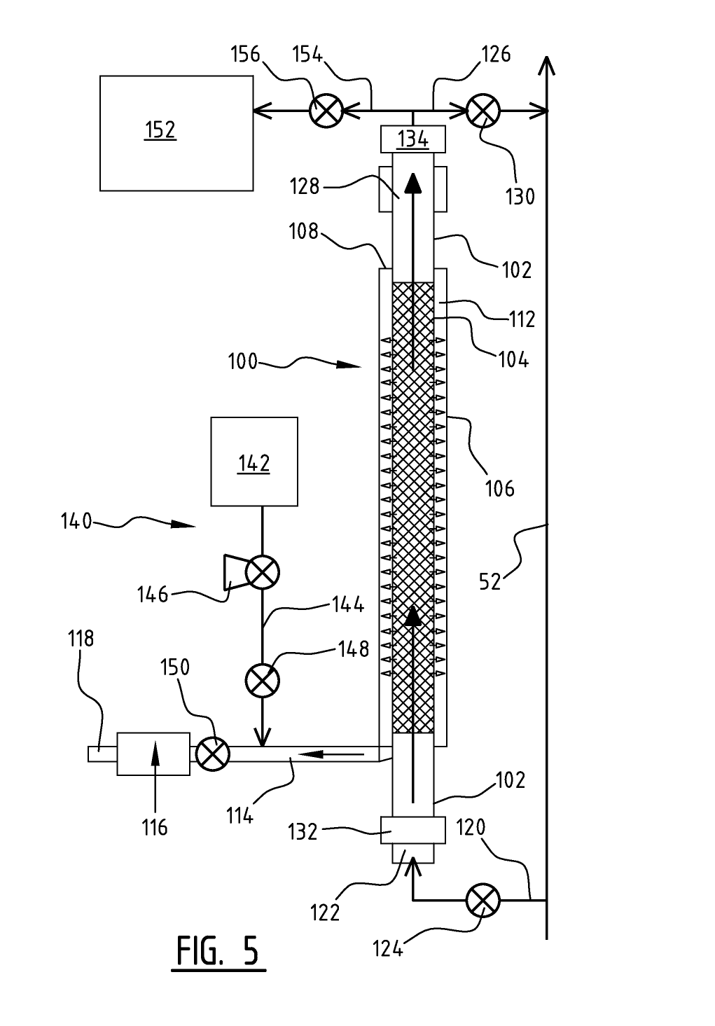

FIG. 5 shows a cross section of another embodiment of the fluid loss sensor according to the invention; and

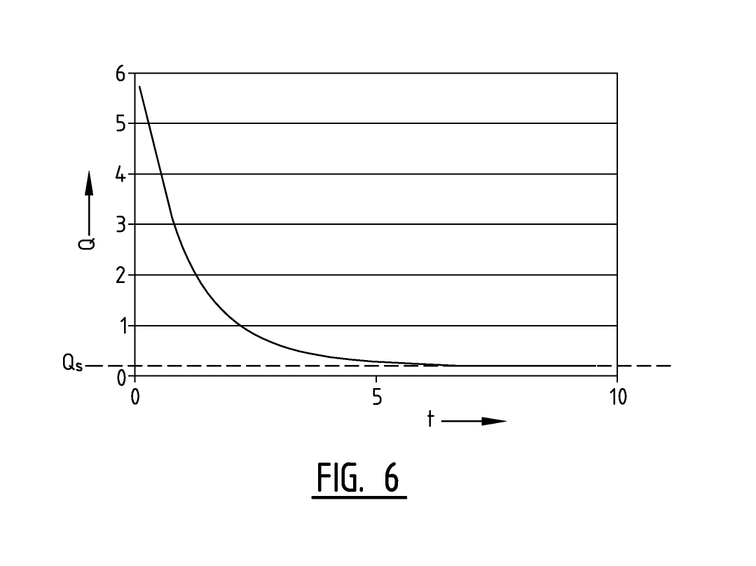

FIG. 6 shows an exemplary diagram of a fluid loss outflow Q in time t as measured by the fluid loss sensor of the invention.

The present invention is directed to fluid loss in drilling operations. The drilling operations include, but are not limited to, oilfield wellbores. In the description, like reference numerals relate to like components.

FIGS. 1 and 2 show a drilling system 1 including a drilling rig 10 and a drill string 12 suspended from said rig at surface 4 into a borehole 6 formed in an earth formation 8. The drill string 12 can be several kilometres in length. The drill string typically comprises lengths of drill pipe 14 screwed together end to end. The drilling rig 10 may be any sort of oilfield, utility, mining or geothermal drilling rig, including: floating and land rigs, mobile and slant rigs, submersible, semi-submersible, platform, jack-up and drill ship.

A bottom hole assembly (BHA) 16 is positioned at the downhole end of the drill string 12. The bottom hole assembly (BHA) 16 may include one or more sections of drill collar and/or heavy weight drill pipe, each having an increased weight with respect to the drill pipe sections 14, to provide the necessary weight on bit during drilling. In addition, the BHA 16 may comprise a transmitter 18 (which may be for example a wireline telemetry system, a mud pulse telemetry system, an electromagnetic telemetry system, an acoustic telemetry system, or a wired pipe telemetry system), centralisers 20, a directional tool 22 (which can be sonde or collar mounted), stabilisers (fixed or variable) and a drill bit 28.

During drilling, the drill string 12 together with the BHA and the drill bit may be rotated by a drive system 30, provided at the drilling rig 10. The drilling system 30 may rotate the drill string 12 and thereby the drill bit 28. In case a downhole motor or turbine is used, drill string rotational speed is (much) lower then bit rotational speed.

Presently most drilling systems include so-called top drives. However, some drilling rigs use a rotary table and the invention is equally applicable to such rigs. The invention is also equally useful in drilling any kind of borehole e.g. straight, deviated, horizontal or vertical.

A pump 32 may be located at the surface. During drilling, the pump 32 pumps drilling fluid through the drill string 12 and through the drill bit 28. The drilling fluid is typically pumped via fluid supply line 52 into the top drive 30 and subsequently into an internal fluid passage of the drill string. The drilling fluid cools and lubricates the drill bit during drilling, and returns cuttings to the surface via an annulus 54 formed between the drill string 12 and the wellbore wall 56. At surface, the return flow of drilling fluid arrives at wellhead 58 and is guided via fluid discharge line 60 to a suitable drilling fluid discharge system 62. The latter may comprise for instance an artificial pond 64.

Alternatively, the fluid loss sensor 100 may be included in a separate fluid circuit 70 connected to the mud tank 64 (FIG. 3). The fluid circuit may comprise a fluid pump 72 to pump fluid from the drilling fluid reservoir 64 through a feed line 76 to the sensor 100, and a discharge line 74 to discharge the drilling fluid into the reservoir 64.

According to the invention, a fluid loss sensor 100 may be included in the fluid supply line 52 (FIG. 1), the fluid discharge line 60 (FIG. 2) and/or have a separate fluid circuit connected to the drilling fluid reservoir 64 (FIG. 3).

The system may include a user control unit 34. Drilling data and information may be displayed on a screen 36 of the control unit 34. The control unit may typically include a user input device such as a keyboard (not shown) for controlling at least part of the drilling process. A logic controller 38 sends and receives data to and from the console 34 and the top drive 30. In particular, an operator may be able to set a speed command and a torque limit for the drive system to control the speed at which the drill string rotates. Similarly, data provided by the sensor 100 can be monitored and the operator may control the sensor 100.

The sensor 100 may comprise a first pipe 102 having a permeable section 104 (FIG. 4). A second pipe 106 encloses the permeable section. The second pipe is provided with first and second end caps 108, 110 respectively to seal an annulus 112 between the permeable section 104 and the second pipe 106. Sensor conduit 114 connects the annulus 112 to a flow rate sensor 116, having fluid discharge end 118.

In an embodiment, the sensor of the invention comprises a cylindrical permeable membrane 104 which is arranged inside a non-permeable cylinder 106. The pressure difference across the membrane 104 can be controlled.

As shown in FIG. 4, the sensor 100 may be connected to the fluid supply line 52. Alternatively or in addition, the sensor 100 may be connected to the fluid discharge line 60 in a similar fashion.

A first conduit 120 connects the fluid supply line 52 to a first end 122 of the first pipe 102. The first conduit may be provided with a first valve 124. A second conduit 126 connects a second end 128 of the first pipe 102 to the fluid supply line 52, downstream of the first conduit 120. The second conduit 126 may be provided with a second valve 130.

Said first valve 124 may be a flapper valve, having an open and a closed position. In an improved embodiment, said first valve may be a choke valve which is controllable to a partial open position, between said open and said closed position. The latter enables to adjust the fluid flow rate to any value between zero and a maximum flow rate determined by the open position.

Said second valve 130 may be a simple valve to prevent fluid flow in the opposite direction. The second valve may for instance be a one-way valve, for instance a flapper valve.

Optionally (FIG. 5), the sensor 100 may be provided with one or more flow rate sensors 132, 134. A first flow rate sensor 132 may be provided at the inlet 122 of the sensor 100. A second flow rate sensor 134 may be provided at the primary outlet 128 of the sensor 100. The flow rate sensors 132, 134 allow to relate the fluid loss rate as measured by flow rate sensor 116 to the fluid flow in the first pipe 102. Comparing the flow rate measured by the second flow rate sensor 134 to the flow rate measured by the first flow rate sensor 132 allows to check the fluid loss rate measured by the sensor 116. The flow rate sensors 132, 134 thus enable to improve the accuracy of the fluid loss sensor 100.

In an embodiment (FIG. 5), the sensor 100 may include a cleaning assembly 140. The cleaning assembly may comprise a cleaning fluid reservoir 142 which is connected to the annulus 112. The reservoir 142 is for instance connected to the sensor conduit 114 via a cleaning fluid conduit 144. Said cleaning fluid conduit may be provided with a fluid pump 146 and a third valve 148. Said third valve may be a one-way valve, allowing passage of cleaning fluid from the reservoir 142 towards the sensor conduit 114. A fourth valve 150 may be provided in the sensor conduit 114 downstream of the cleaning fluid conduit 144, i.e. between the fluid loss rate sensor 116 and the cleaning fluid conduit 144. The fourth valve may block passage of cleaning fluid towards the flow rate sensor 116.

A cleaning fluid discharge vessel 152 may be connected to one end of the first pipe 102, for instance to the second end 128. Alternatively, the discharge vessel 152 may be connected to the second end 122. A cleaning fluid discharge conduit 154, connecting said respective end of first pipe 102 to the vessel 152, may be provided with a valve 156.

The cleaning fluid may comprise water. Alternatively, the cleaning fluid may comprise a solution such as chlorine bleach, hydrogen chloride (HCl), nitric acid (HNO₃), hydrochloric acid or hydrogen peroxide (H₂O₂). The latter allows chemical cleaning, wherein the membrane 104 is soaked with the solution. First the solution soaks into the membrane for a certain time, for instance a number of minutes. After that a forward flush or backward flush is applied, causing the contaminants to be rinsed out of the membrane. Forward flush herein indicates fluid flow from the inlet 122 towards the secondary outlet 114. Backward flush indicates fluid flow from the secondary outlet 114 towards one or both of the inlet 122 and the primary outlet 128.

Another cleaning method is the so-called air flush or air/water flush. Herein, the cleaning fluid comprises air. The cleaning method is a forward flush or backward flush during which air is injected in the pipe. The air is injected, creating a more turbulent and therefore effective cleaning system.

In an alternative embodiment, the cleaning assembly may include mechanical cleaning means for cleaning the permeable section 104. For instance, one or more sponge balls made of polyurethane or other materials may be inserted into the permeable section 104 for scrubbing the filter cake from the inner surface of the membrane.

In practice, cleaning methods as described above are often combined.

Regarding cleaning methods, reference is made to Chapter 3 of JoséMiguel Arnal, Beatriz García-Fayos and María Sancho (2011), “Membrane Cleaning, Expanding Issues in Desalination”, Prof. Robert Y. Ning (Ed.), ISBN: 978-953-307-624-9, InTech.

During drilling, drilling fluid will be supplied via the fluid supply line 52. A part of the drilling fluid flow is diverted via the sensor 100. The diversion of drilling fluid can be controlled by inflow control valve 124. The diverted drilling fluid flows through the first pipe 102 and inside the membrane 104, from the first end 122 in the direction of the second end 128.

The inflow control valve 124 sets the pressure of the drilling fluid inside the membrane 104 at a first pressure. A second pressure in the annulus 112 is set to be lower than the first pressure. The additives in the drilling fluid will form a filter cake on the inner surface of the permeable section 104. Due to the pressure differential across the permeable section 104 and because of the under-pressure in the annulus 112, part of the drilling fluid will permeate through the membrane 104 and flow into the annulus 112. The fluid that flows into the annulus 112 is collected, directed towards the flow rate sensor 116 and measured.

The flow rate Q and/or the volume of fluid as measured by the sensor 116 will indicate the quality of the filter cake. For a drilling fluid which deposits a poor quality filter cake, the amount of fluid that flows into the annulus 112 is higher than for a drilling fluid which deposits a good quality filter cake.

FIG. 6 shows an exemplary diagram indicating the dependence of fluid flow rate Q on time t. At time t0, the membrane 104 of the sensor 100 is clean, allowing a certain flow of drilling fluid to pass. As time passes, the additives in the drilling fluid will deposit a filter cake on the inner surface of the membrane 104, which will at least partially limit the permeability of the membrane 104, causing a reduction of the fluid flow rate Q. After a certain time, for instance time t is about 5 or 6 as shown in FIG. 6, the flow rate Q will reach a steady state flow rate Qₛ. Herein, Q may for instance be expressed in [litre/minute] or [μl/sec]. Time t may for instance be expressed in seconds, minutes, or hours. Please note that the numbers shown in FIG. 6 are dimensionless, i.e. these numbers merely present an abstract example.

Diagrams indicating the dependence of fluid flow rate versus time t may be predetermined, for instance in laboratory tests. A standard set of diagrams, as provided by said tests, may be indicative for the filter cake and permeability thereof as provided by, for instance, a certain additive, combinations of additives, relative volumes of additives in the drilling fluid (for instance expressed in weight percentage or volume percentage), etc. The latter may also indicate the flow diagram of a proper filter cake, and failure to form a proper filter cake. It may also be possible to determine threshold values for fluid flow rates at certain time intervals or in the steady state, indicating a cross over between proper filter cake and unacceptable permeability of the filter cake.

The standard set of diagrams may be stored in a database. During drilling, the flow rate sensor 116 may provide flow rate data to the logic controller 38. The logic controller uses the flow rate date to generate a flow rate diagram. Upon reaching the steady state flow rate, the logic controller may compare the generated diagram with the set of standard diagrams. The logic controller may issue an alarm signal if the measured flow rate at any point in time exceeds the predetermined threshold slow rate. For instance if the steady state flow rate Qₛ exceeds the threshold steady state flow rate Q_{s,t}, the logic controller may issue an indication that something is wrong, urging the drilling fluid operator to adjust the additives in the drilling fluid. Said indication may be displayed by the user control unit 34. Alternatively, an alarm may sound.

For cleaning purposes, the under-pressure in the annulus 112 is reversed into an overpressure at a set time. Valves 150, 124, and 130 are closed. Valves 156 and 148 are opened. The pump 146 forces cleaning fluid into the annulus 112 and through the membrane 104 to remove the filter cake from the inner surface of the permeable section. The cleaning fluid is discharged into the discharge tank 152. The cleaning process may be repeated, for instance at preselected intervals. The interval may be in the order of 0.5 to 2 hours.

In an embodiment, along the permeable section 104 the wall of the pipe 102 may be provided with openings to allow fluid passage. The number and diameter of said openings provides the permeable section 104 with a preselected permeability to drilling fluid.

In another embodiment, the permeable section 104 is provided with a membrane having a preselected permeability to drilling fluid.

Said preselected permeability may be of the same order of magnitude as the permeability of one or more of the layers in the earth which will be pierced by the borehole.

Examples of permeability of rocks typically encountered in layers in the earth are provided in table 1 below [Source: Bear, Jacob; 1972; Dynamics of Fluids in Porous Media; ISBN 0-486-65675-6].

TABLE 1

| Permeability | Pervious | | | | Semi-Pervious | | | | Impervious | | | | |
|---|---|---|---|---|---|---|---|---|---|---|---|---|---|
| Unconsolidated | Well Sorted | | Well Sorted | | | Very Fine Sand, Silt, | | | | | | | |
| Sand & Gravel | Gravel | | Sand or Sand & | | | Loess, Loam | | | | | | | |
| | | | Gravel | | | | | | | | | | |
| Unconsolidated | | | | | Peat | | Layered Clay | | | Unweathered Clay | | | |
| Clay & Organic | | | | | | | | | | | | | |
| Consolidated | Highly Fractured | | | | Oil Reservoir | | | Fresh | | Fresh | | Fresh | |
| Rocks | Rocks | | | | Rocks | | | Sandstone | | Limestone, | | Granite | |
| | | | | | | | | | | Dolomite | | | |
| κ (cm²) | 0.001 | 0.0001 | 10⁻⁵ | 10⁻⁶ | 10⁻⁷ | 10⁻⁸ | 10⁻⁹ | 10⁻¹⁰ | 10⁻¹¹ | 10⁻¹² | 10⁻¹³ | 10⁻¹⁴ | 10⁻¹⁵ |
| κ (millidarcy) | 10⁺⁸ | 10⁺⁷ | 10⁺⁶ | 10⁺⁵ | 10,000 | 1,000 | 100 | 10 | 1 | 0.1 | 0.01 | 0.001 | 0.0001 |

In Table 1, κ is the intrinsic permeability [length²]. Based on the Hagen-Poiseuille equation for viscous flow in a pipe, permeability can be expressed as:

κ=C*d²

wherein C is a dimensionless constant that is related to the configuration of the flow-paths, and d is the average, or effective pore diameter [length].

In a practical embodiment, the permeable section 104 has a permeability to drilling fluid which is of the same order of magnitude as the permeability of one or more of the layers of the formation. Optionally, a separate sensor may be used for each respective layer of the formation, thus enabling to match the permeability of the respective permeable section of the sensor to the permeability of the respective section of the borehole that is being drilled, thus improving the accuracy of the fluid loss sensor. Examples of the permeability are provided in table 1 above.

In a practical embodiment, the first valve 124 chokes the inflow of drilling fluid to allow a predetermined pressure difference across the permeable section 104. Said predetermined pressure difference may be substantially equal to, or in the same order of, a pressure difference between the drilling fluid in the borehole and the pore pressure in the formation enclosing said borehole. In practice, the predetermined pressure difference may be in the range about of 5 to 50 bar, for instance about 10 to 15 bar. The pressure at the discharge end 118 of the flow rate sensor 116 may be equal to atmospheric pressure (i.e. about 1 bar). A pressure in the annulus 112 and the sensor conduit 114 may therefore be slightly exceed 1 bar, for instance about in the range of 1.05 to 1.5 bar. Then, the fluid pressure inside the permeable section 104 may be set in the range of about 5 to 50 bar. In an embodiment, first valve 124 is controlled to set the pressure inside the permeable section 104 in the range of about 10 to 15 bar. Herein, please note that the fluid pressure in the inflow line 52 during drilling may typically be in the range of 200 to 400 bar, and may be much higher, for instance up to 1200 bar.

In an embodiment, the permeable section 104 may have a length in the range of about 10 cm to 10 meter. The length may for instance be in the order of 2 meter. A diameter of the permeable section may be in the range of about 1 to 35 cm. In practice, the diameter of the permeable section may be several inches. Flow rate of drilling fluid from the first end 122 towards the second end 128 of the first pipe may be about 5 to 50 litre per minute [l/min], for instance about 10 l/min. Herein, flow rate in the corresponding fluid supply line 52 may be in the order of 1000 l/min. Flow rate at the flow rate sensor may be about 10 to 1000 ml/min, for instance about 100 ml/min.

The permeable section may comprise a membrane suitable for pressure driven filtration. The membrane will have a pore size suitable for particle filtration. The pores or openings may have a diameter in the order of about 10 to 1000 μm, for instance about 10 to 100 μm.

The permeable section may comprise a tangential flow membrane. Fouling is in principle limited due to the sweeping effects and shear rates of the passing fluid flow. The permeable section may be constructed from (synthetic) membrane devices such as flat plates, spiral wounds, and hollow fibers.

The permeable section 104 may for instance comprise a pipe made of carbon steel, stainless steel or any suitable corrosion resistant metal or metal alloy. Said pipe may be provided with a number of openings to allow fluid passage. The number and the diameter of said openings enables to set the permeability of the permeable section at a predetermined value. The openings may for instance be made by laser perforation or by waterjet.

Alternatively, the membrane may be constructed from spiral wounds which are constructed from flat membranes but in a form of a “pocket” containing two membrane sheets separated by a highly porous support plate. Several such pockets are then wound around a tube, such as tube 102, to create a tangential flow geometry and to reduce membrane fouling.

The membrane may also comprise a hollow fiber module, comprising an assembly of self-supporting fibers with a dense skin separation layer, and a more open matrix helping to withstand pressure gradients and maintain structural integrity. The hollow fiber module can contain up to 10,000 fibers ranging from 200 to 2500 μm in diameter. The main advantage of a hollow fiber module is a relatively large surface area within an enclosed volume, increasing the efficiency of the separation process.

The present invention is not limited to the above-described embodiments thereof, wherein various modifications are conceivable within the scope of the appended claims. For instance, features of respective embodiments may be combined.

1. A fluid loss sensor comprising:
a first fluid container, comprising a permeable section, a fluid inlet and a first fluid outlet;
a second fluid container enclosing an outer surface of the permeable section and having a second fluid outlet; and
a fluid flow sensor for measuring fluid flow in the second fluid outlet.

2. The sensor of claim 1, comprising a cleaning assembly for automated cleaning of the permeable section.

3. The sensor of claim 2, the cleaning assembly comprising:
a cleaning fluid reservoir comprising cleaning fluid;
a cleaning fluid conduit connecting the cleaning fluid reservoir to the fluid outlet of the second fluid container and/or to the fluid inlet; and
a pump for pumping said cleaning fluid into the fluid outlet or into the fluid inlet.

4. The sensor of claim 3, the cleaning assembly further comprising:
a cleaning fluid discharge tank.

5. The sensor of claim 4, the cleaning assembly further comprising:
a valve for opening and closing the cleaning fluid conduit;
a valve for opening and closing fluid passage to the flow rate sensor; and
a valve for opening and closing fluid passage to the cleaning fluid discharge tank.

6. The sensor of claim 3, the cleaning fluid comprising air.

7. The sensor of claim 6, the cleaning fluid comprising a mixture of water and air.

8. The sensor of claim 3, the cleaning fluid comprising a chemical cleaning, allowing chemical cleaning of the permeable section by soaking of the permeable section with the chemical cleaning solution.

9. The sensor of claim 8, wherein the chemical cleaning solution is selected from: chlorine bleach, hydrogen chloride (HCl), nitric acid (HNO3), hydrochloric acid or hydrogen peroxide (H2O2).

10. The sensor of claim 2, the automated cleaning assembly comprising mechanical cleaning means for cleaning the permeable section.

11. The sensor of claim 10, the mechanical cleaning means comprising scrubbing means for scrubbing a filter cake from a surface of the permeable section.

12. The sensor of claim 11, the scrubbing means comprising sponge balls.

13. The sensor of claim 1, wherein the first fluid container is a first pipe, and wherein the second fluid container is a second pipe enclosing the first pipe.

14. The sensor of claim 1, comprising an inflow control valve to control inflow of fluid into the fluid inlet.

15. The sensor of claim 1, wherein the permeable section comprises a metal membrane provided with a number of fluid passages, the number of the fluid passages and the diameter of the fluid passages providing the metal membrane with a preselected permeability.

16. Drilling system for drilling a borehole, comprising:
a drill string;
a fluid supply line for supplying fluid to an uphole end of the drill string;
a pump for pumping fluid into the drill string via the fluid supply line; and
the fluid loss sensor of claim 1, wherein the fluid inlet is connected to the fluid supply line and wherein the first fluid outet is connected to the fluid supply line downstream of the fluid inlet.

17. Drilling system for drilling a borehole, comprising:
a drill string;
a fluid supply line for supplying fluid to an uphole end of the drill string;
a pump for pumping fluid into the drill string via the fluid supply line;
a fluid discharge line for discharging the fluid from the borehole; and
the fluid loss sensor of claim 1, wherein the fluid inlet is connected to the fluid discharge line and wherein the first fluid outlet is connected to the fluid discharge line downstream of the fluid inlet.

18. Drilling system for drilling a borehole, comprising:
a drilling fluid reservoir;
a fluid circuit connected to the fluid reservoir, the fluid circuit comprising:
a feed line connected to the reservoir;
a fluid pump to pump fluid from the drilling fluid reservoir through the feed line;
the fluid loss sensor according to claim 1 to receive fluid from the feed line; and
a discharge line to discharge the drilling fluid into the reservoir.

19. A method for monitoring fluid loss, comprising the steps of:
guiding at least part of a fluid stream to a fluid inlet of a first fluid container, the first container comprising a permeable section and a first fluid outlet;
providing a second fluid container enclosing an outer surface of the permeable section and having a second fluid outlet; and
measuring fluid flow in the second fluid outlet using a fluid flow sensor.

20. The method of claim 19, comprising the step of controlling an inflow of fluid into the fluid inlet.

21. The method of claim 19, comprising the step of cleaning of the permeable section when the measured fluid flow in the second fluid outlet drops below a predetermined threshold.
